(19) United States
(12) Patent Application Publication
(10) Pub. No.: US 2024/0116358 A1
(43) Pub. Date: Apr. 11, 2024

(54) DISCONNECT DIFFERENTIAL

(71) Applicants: VCST INDUSTRIAL PRODUCTS BV, Sint-Truiden (BE); SaLa Drive GmbH, Grieskirchen (AT)

(72) Inventors: Gilles HERBILLON, Jehay (BE); Pranav BARVE, Heverlee (BE); Harald HINTERWALLNER, Passau (DE)

(21) Appl. No.: 18/264,602

(22) PCT Filed: Feb. 8, 2022
(86) PCT No.: PCT/EP2022/052954

§ 371 Date: Aug. 8, 2023

(30) Foreign Application Priority Data
Feb. 8, 2021 (EP) 21155866.3

(51) Int. Cl. F16D 11/10; B60K 1/00; B60K 17/02; B60K 17/16; F16H 37/08; F16H 48/10; F16H 57/037

(52) U.S. Cl. CPC F16D 11/10; B60K 1/00; B60K 17/02; B60K 17/165; F16H 37/0813; F16H 48/10; F16H 57/037; F16H 2057/02052

(57) ABSTRACT

A differential assembly for a vehicle includes: an input member; a first output member and a second output member; a differential mechanism for differentially distributing a driving force inputted by the input member to the first output member and the second output member; a differential case that accommodates the differential mechanism; and a clutch mechanism for selectively transmitting power between the input member and the differential case, the clutch mechanism having a first engaging member and a second engaging member to be releasably connected to one another such that the clutch mechanism is in a coupled state when the first engaging member and the second engaging member are engaged, and the clutch mechanism is in a decoupled state when the first engaging member and the second engaging member are disengaged. The first engaging member includes at least one cavity in which a recess is arranged.

### CROSS-REFERENCE TO PRIOR APPLICATIONS

This application is a U.S. National Phase application under 35 U.S.C. § 371 of International Application No. PCT/EP2022/052954, filed on Feb. 8, 2022, and claims benefit to European Patent Application No. EP 21155866.3, filed on Feb. 8, 2021. The International Application was published in English on Aug. 11, 2022 as WO/2022/167678 under PCT Article 21(2).

### FIELD

The invention relates to a differential assembly, a transmission assembly comprising the differential assembly, as well as a power train comprising the transmission assembly.

### BACKGROUND

New types of transmissions for pure electric vehicles (a.k.a. “e-Drives”) have been developed. Nowadays, most of the passenger cars are electrified according to a “skate board” layout, this configuration can also be called “DUAL-AXLE” drive (where the front & rear axles are both equipped with their own electric drive unit, where the front & rear axles are not mechanically connected to each other, because the battery pack is integrated between the front & rear axles and does not allow the use of a longitudinal shaft). Such DUAL-AXLE layouts experience limitations when the full torque at the wheels is not required: in this case, one of the axles (usually called “the secondary axle”) should preferably be disconnected in order not to produce a drag torque that could be created by the drag torque of the e-machine—in case a permanent magnet technology is used—or by the friction losses in the transmissions—including losses in gear meshes, losses in the bearings, or churning losses in case of wet sumps. A complete disconnection (that could occur at standstill, but also during the drive, e.g. coast-down motion) makes sense. Furthermore, when a passive lubrication system is selected (also called “oil-dipping” or “oil splashing”), the “churning” losses resulting from the contact between rotating members of the transmission and the oil bath reduce efficiency, especially during coast down operation.

US 2017/292596 discloses a differential.

### SUMMARY

In an embodiment, the present invention provides a differential assembly for a vehicle, comprising: an input member; a first output member and a second output member; a differential mechanism configured to differentially distribute a driving force inputted by the input member to the first output member and the second output member; a differential case that accommodates the differential mechanism; and a clutch mechanism configured to selectively transmit power between the input member and the differential case, the clutch mechanism comprising a first engaging member and a second engaging member configured to be releasably connected to one another such that the clutch mechanism is in a coupled state when the first engaging member and the second engaging member are engaged, and the clutch mechanism is in a decoupled state when the first engaging member and the second engaging member are disengaged, wherein the first engaging member comprises at least one cavity in which a recess is arranged, and the second engaging member comprises at least one protrusion, the recess being configured to engage with the at least one protrusion so as to transmit the power either from the first engaging member to the second engaging member, or from the second engaging member to the first engaging member, when the clutch mechanism is in the coupled state, and wherein the at least one cavity extends in a circumferential direction and is arranged such that the first engaging member is movable relative to the second engaging member during a switching from the decoupled state to the coupled state such that the at least one protrusion is movable, from the decoupled state, through the at least one cavity into the recess.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 or 1A illustrates a differential assembly according to an embodiment of the invention. FIG. 1A is FIG. 1 with hatched sections.

FIG. 2 shows a view of a sliding sleeve comprising cavities in which the recesses are arranged according to an embodiment of the invention.

FIGS. 3A and 3B show views of a sliding sleeve according to another embodiment of the invention.

FIG. 4A shows a transversal cut of a cavity and a protrusion, when torque is transferred from an input member to a differential case.

FIG. 4B shows a transversal cut of a cavity and a protrusion when an electric motor is either in a reverse mode or driven by wheels.

FIG. 4C shows a transversal cut of a cavity and a protrusion in a switching operation from a decoupled state to a coupled state in which the electric motor drives the vehicle.

FIG. 5 shows a view of an input member with protrusions circumferentially arranged according to another embodiment of the invention.

FIG. 6 shows a schematic representation of an embodiment of a power chain with an electric motor in an off-set configuration and a differential assembly according to the invention.

FIG. 7 shows a transversal view of a transmission assembly in an off-set configuration according to the invention.

FIG. 8 shows a front view of the first half of a transmission casing of the transmission assembly of FIG. 7.

FIG. 9 shows a schematic representation of an embodiment of a power chain with an electric motor in coaxial configuration and a differential assembly according to the invention.

FIGS. 10A and 10B show a transversal view and a rear view, respectively, of a “coaxial” transmission assembly according to the invention.

FIG. 11A shows a schematic representation of an embodiment of a power chain with an electric motor in an off-set configuration and a differential assembly, in which the first and the second engagement member each comprise a plurality of teeth.

FIG. 11B shows a schematic representation of an embodiment of a power chain with an electric motor in coaxial configuration and a differential assembly, in which the first and the second engagement member each comprise a plurality of teeth.

### DETAILED DESCRIPTION

In an embodiment, the present invention provides a solution to at least one drawback of the teaching provided by the prior art, in particular a transmission with high efficiency and simplicity.

In an embodiment, the present invention provides a transmission with a reduced clutch response time.

For the above purpose, the invention is directed to a differential assembly for a vehicle comprising: an input member; a first and a second output member; a differential mechanism that allows a driving force inputted by the input member to be differentially distributed to the first and the second output member; a differential case that accommodates the differential mechanism; and a clutch mechanism arranged to selectively transmit power between the input member and the differential case, said mechanism comprising a first and a second engaging member adapted to be releasably connected to one another such that the clutch mechanism is in a coupled state when the first engaging member and the second engaging member are engaged and the clutch mechanism is in a decoupled state when the first engaging member and the second engaging member are disengaged; preferably (the first engaging member comprises at least one cavity, in which a recess is arranged, and the second engaging member comprises at least one protrusion, said recess being adapted to engage with the at least one protrusion so as to transmit the power either from the second to the first engaging member or from the first to the second engaging member, when the clutch mechanism is in a coupled state, more preferably in that the at least one cavity extends in a circumferential direction and is arranged so that the first engaging member can move (i.e. is movable) relative to the second engaging member during a switching from the decoupled state to the coupled state, so that the at least one protrusion can be moved (i.e. is movable), from the decoupled state, through the at least one cavity into the recess, more preferably when the at least one protrusion slides through the at least one cavity towards said recess).

According to specific embodiments of the invention, the differential assembly comprises one or more of the following technical features, taken in isolation, or any combination thereof:
the input member comprising the second engaging member and the differential case comprising the first engaging member;
the recess being arranged (e.g. positioned) at a circumferential end portion of the at least one cavity;
wherein, in the coupled state, the at least one protrusion rests against an abutment surface formed on a portion of the recess, in particular when the torque is transmitted from the second to the first engaging member;
wherein, in the coupled state, the at least one protrusion can be inserted into the recess in a form-fitting manner;
wherein in the coupled state, the at least one protrusion rests against an opposed abutment surface to the abutment surface formed on the portion of the recess when the torque is transmitted from the first to the second engaging member, the abutment surface having a higher surface than the opposed abutment surface;
wherein the opposed abutment surface being formed on another portion of the recess faces the abutment surface formed on the portion of the recess;
wherein the first engaging member comprises a front face, in which the at least one cavity is arranged;
wherein the second engaging member comprises a front face, said face resting against the first engaging member front face when the clutch mechanism is in a coupled state;
wherein the at least one cavity extends in a circumferential direction;
wherein the at least one cavity has a circular arc shape, extending between two opposite circumferential edges formed in the front face of the first engaging member;
wherein the at least one cavity has an inner radial edge and an outer radial edge formed in the front face of the first engaging member or the at least one cavity radially extends from the inner radius of the first engaging member to the other radius of the engaging member;
wherein the at least one cavity comprises a ramp;
wherein the ramp is arranged at an end of the cavity that is opposite to the recess in the circumferential direction;
wherein the ramp comprises a surface forming an angle with a bottom of the at least one cavity, said surface connecting the front face of the first engaging member with said bottom;
wherein the ramp circumferentially extends from the front face of the first engaging member to the recess;
wherein the recess comprises an undercut or two opposed undercuts, preferably the at least one protrusion comprising two opposite side surfaces, adapted to be complementary to the two opposed undercuts of the recess;
wherein the at least one protrusion comprises a side surface, adapted to be complementary to the incline of the ramp or to the undercut of the recess;
wherein the at least one protrusion comprises a flat head, the incline of which is adapted to be complementary to the incline of the ramp;
wherein the flat head of the at least one protrusion comprises a chamfer formed on an edge of said head, the incline of which is adapted to slide on the ramp;
wherein the clutch mechanism is arranged so as to allow the first engaging member to move relative to the differential case in an axial direction along a rotation axis of the differential case and not to allow the first engaging member to rotate relative to the differential case, wherein the second engaging member is formed in or fixed to the input member, wherein, in the coupled state, the input member synchronously rotates with the differential case, wherein in the decoupled state the differential case and the input member are disconnected from each other so as to allow the relative rotation between the input member and the differential case;
wherein the input member comprises a final wheel;
wherein the differential assembly comprises an outer annular housing and inner annular housing arranged coaxially, wherein the outer annular housing is part of the input member and the inner annular housing is part of the differential case;
wherein the differential case comprises a proximal axial annular extension supporting in translation without rotation the first engaging member, preferably via one or more inner splines extending axially on an inner surface of the engaging member;
wherein the outer annular housing is rotatably supported by a proximal and distal row of bearings arranged on both sides of the differential mechanism;
wherein the outer annular housing comprises a flange extending radially, said flange comprising a rear face opposing the front face of the first engaging member, the annular housing flange comprising the at least one protrusion extending from a distal to a proximal direction along the axial axis;
wherein the first engagement member is disposed between the flange of the outer annular housing and the proximal row of bearing;
wherein the at least one protrusion comprises at least five and less than twelve protrusions and/or the at least one cavity comprises at least five cavities and less than twelve cavities;
wherein the at least one protrusion and/or the at least one cavity is arranged circumferentially;
wherein the differential assembly is a planetary differential assembly, wherein the differential mechanism comprises a pair of sun gears and at least one planetary gear.

The invention can also relate to a transmission assembly comprising the above-mentioned differential assembly, said transmission assembly comprising a transmission casing housing said differential assembly.

According to specific embodiments of the invention, the transmission assembly comprises one or more of the following technical features, taken in isolation, or any combination thereof:
wherein the first engaging member comprises a peripheral groove, in which a fork-type shifter is engaged, said shifter being connected to an actuator, preferably mounted on the transmission casing;
a first transfer shaft comprising a final pinion meshing with the final wheel of the differential assembly, said shaft having a first rotation axis parallel to the rotation axis of the differential case;
a second transfer shaft comprising a second gear meshing with a first gear disposed on the first shaft, said second shaft having a second rotation axis parallel to the rotation axis of the differential case;
wherein the transmission casing comprises a first and a second half, each half of the transmission casing having the form of a shell, the first and the second half further comprising bearing receiving housings for the first transfer shaft, the second transfer shaft and a proximal and a distal end of the differential case, respectively;
wherein the first and the second half of the transmission casing comprise an opening for accommodating, respectively, the first and the second output members, the second half further comprising an opening for accommodating a second transfer shaft end adapted to be connected to a rotor shaft for an electric motor;
wherein the transmission casing comprises a front cover, in which the differential assembly is supported in rotation;
a transfer shaft comprising a final pinion meshing with the final wheel of the differential assembly, said shaft having a first rotation axis parallel to the rotation axis of the differential case;
a rotor shaft for an electric motor, said shaft having a third gear meshing with a fourth gear disposed on the transfer shaft, said rotor shaft having a rotation axis coaxial with the rotation axis of the differential case, said rotor shaft being preferably a hollow shaft in which one of the output members is disposed.

The invention can also relate to a power chain for a vehicle comprising an electric motor and the above-mentioned transmission assembly.

The present invention is also advantageous since the disconnection of the secondary eAxle from the wheel can be performed by the introduction of a clutch at different potential locations (e.g. between the gear set and the differential unit, or between the final wheel and the planet carrier, or between the differential unit and the wheel). Furthermore, disconnecting the secondary eAxle from the wheels could allow significant savings, and lead to a valuable increase of the battery range (of full electric or hybrid vehicles) or the autonomy (of vehicles equipped with an internal combustion engines).

Nowadays most of the transmissions for electric vehicle are still designed according to an OFFSET LAYOUT where the input shaft and the output shaft are parallel with a certain distance. For better packaging, COAXIAL LAYOUTS are more and more considered: COAXIAL LAYOUTS show an arrangement of the e-machine around the propulsion shaft, and require an e-machine with a central hole (also called “shaft through”), requiring therefore the development of specific e-machines.

Disconnectable devices should preferably be applicable to both types of transmissions: OFFSET or COAXIAL as both types will coexist in a near future.

In general, the preferred embodiments of each subject-matter of the invention are also applicable to the other subject-matters of the invention. As far as possible, each subject-matter of the invention is combinable with other subject-matters. The features of the invention are also combinable with the embodiments of the description, which in addition are combinable with each other.

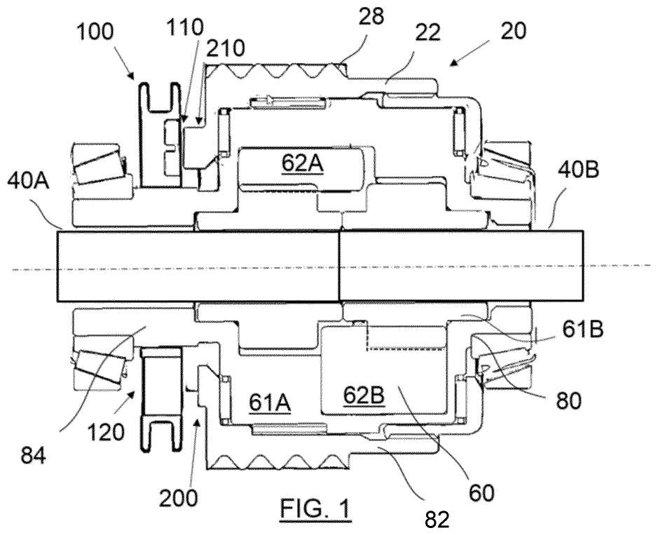

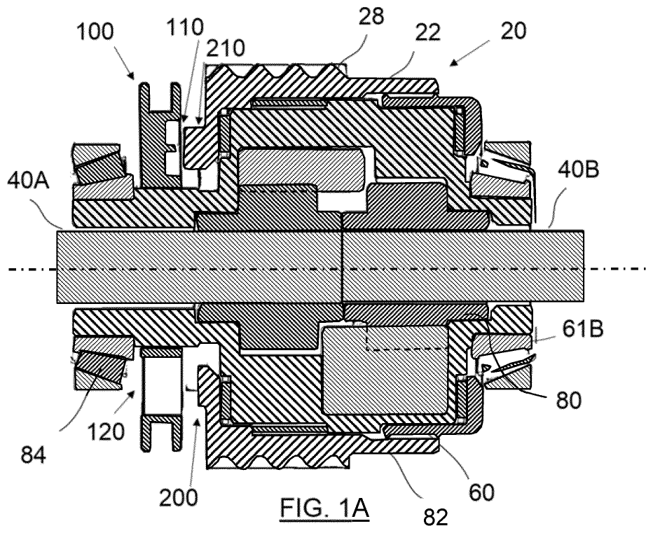

FIG. 1 or 1A illustrates a differential assembly according to an embodiment of the invention. The differential assembly comprises an input member 20, provided with a final wheel 28, the driving force of which is distributed to a first 40A and a second 40B output member, in particular a first 40A and a second 40B shaft respectively connected to vehicle wheels, through a differential mechanism comprising a pair of opposed sun gears 61A, 61B and a pair of planetary gear 62A, 62B, in particular said gears 61A, 61B, 62A, 62B being spur gears.

The differential assembly comprises a clutch mechanism arranged to selectively transmit power between the input member 20 and the differential case 80. The mechanism comprises a first engaging member 100, in particular a sliding sleeve and a second 200 engaging member, in particular protrusions formed on the input member 20. The sliding sleeve 100 and the input member 20 are adapted to be releasably connected to one another such that the clutch mechanism is in a coupled state when the sliding sleeve 100 and the input member 20 are engaged and the clutch mechanism is in a decoupled state when the sliding sleeve 100 and the input member 20 are disengaged.

In FIG. 1 or 1A, the clutch mechanism is arranged so as to allow the sliding sleeve 100 to move relative to a proximal (left hand side) extension 84 of differential case 80, in an axial direction along a rotation axis. The sliding sleeve 100 and the extension 84 are configured so as not to allow the sliding sleeve 100 to rotate relative to the differential case 80. In the coupled state, the protrusions 210 are engaged with the sliding sleeve 100, and therefore the input member 20 synchronously rotates with the differential case 80. Advantageously, the protrusions 210 can be inserted into the recesses 120 in a form-fitting manner. In the decoupled state, as shown in FIG. 1 or 1A, the differential case 80 and the input member 20 are disconnected from each other so as to allow the relative rotation between the input member 20 and the differential case 80. A decoupled state is particularly useful when the vehicle is in coast-down motion. Indeed, even if the first (40A) and second (40B) output members are driven by the vehicle wheels (e.g. front), the input member 20 does not rotate, avoiding for instance oil splash losses.

In FIG. 1 or 1A, the recesses 120 are adapted to engage with the protrusions 210 so as to transmit the power from the protrusion 210 to the sliding sleeve 100, when the electric motor drives the vehicle and the clutch mechanism is in a coupled state. The recesses 120 are also adapted to engage with the protrusions 210 so as to transmit the power from the sliding sleeve 100 to the protrusions 210, when the vehicle has regenerative braking and the clutch mechanism is in a coupled state. In an alternative configuration that is not illustrated, the protrusions could be fixed to or formed on the sliding sleeve and the cavities formed on the input member.

In FIG. 1 or 1A, the differential assembly comprises an outer annular housing 22 and inner annular housing 82 arranged coaxially, wherein the outer annular housing 22 is part of the input member 20 and the inner annular housing 82 is part of the differential case 80. The outer annular housing 22 comprises a flange 26 extending radially, said flange comprising a rear face opposing the front face 180 of the first engaging member 100 (sliding sleeve). The flange 22 comprises the protrusions 210, that extend from a distal to a proximal direction along the axial axis.

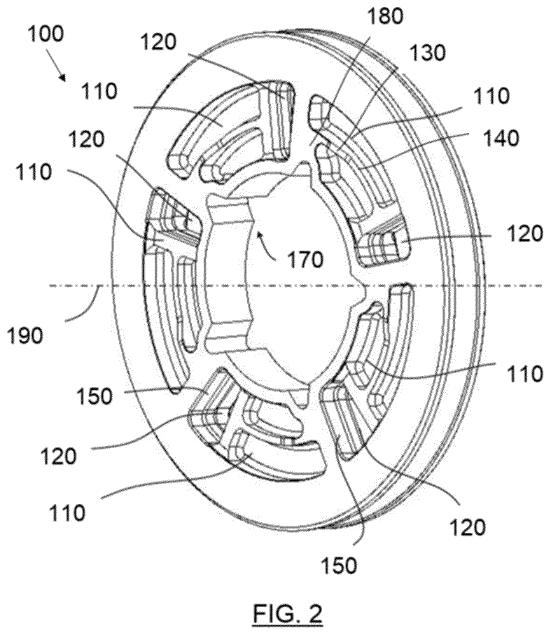

FIG. 2 shows the cavities 110 in which the recesses 120 are arranged. The cavities extend in a circumferential direction and have a circular arc shape, extending between two opposite circumferential edges. The cavities 110 shown have an inner radial edge and an outer radial edge. However, the cavities can also radially extend from the inner radius of the sliding sleeve 100 to the other radius of said sleeve 100. The cavities 110 are arranged so that the first engaging member 100, namely the sliding sleeve, and thus the differential case 80 can move relative to the second engaging member 200 and thus the input member 20, during a switching from the decoupled state to the coupled state, so that the protrusions 210 can be moved, from the decoupled state, through the respective cavities 110 into the corresponding recesses 120.

FIG. 2 shows a front face 180 of the first engaging member 100, namely the sliding sleeve 100. The sliding sleeve 100 comprises cavities 110, in which a recess 120 is arranged. Advantageously, the recesses 120 are arranged at a circumferential end portion of their cavity 110. In the coupled state, the protrusions 210 rests against a first abutment surface 150 formed on a portion of the recesses 120 when the electric motor drives the vehicle, or a second (opposed) abutment surface when the electric motor is driven by the vehicle or the electric motor drives the vehicle in reverse. The first abutment surface 150 preferably has a higher surface than the second abutment surface 150. Preferably, the cavities 110 comprises a ramp 130. Each ramp 130 can be arranged at an end of its cavity, said end being opposite to the recess 120 in the circumferential direction.

Advantageously, the ramps 130 comprise a surface forming an angle with a bottom 140 formed in the same cavity 110, wherein the surface connects the front face 180 of the sliding sleeve with the bottom 140.

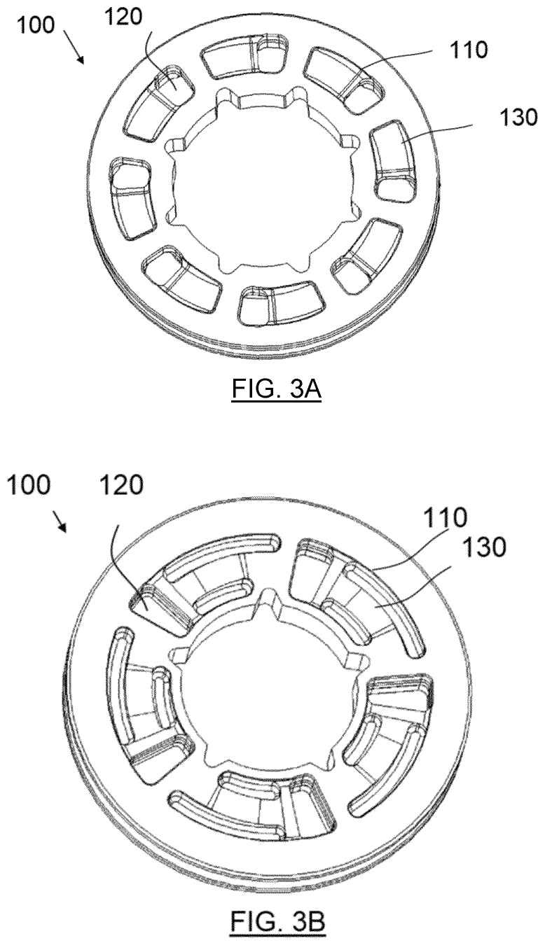

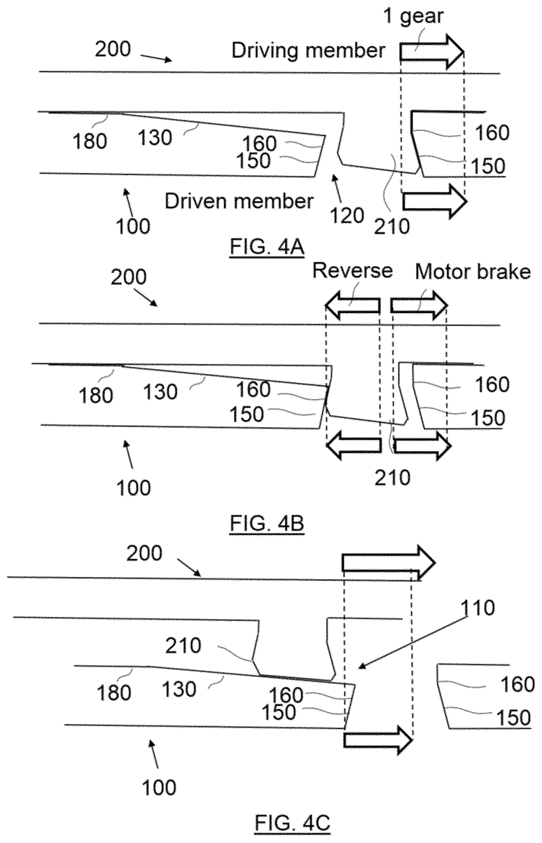

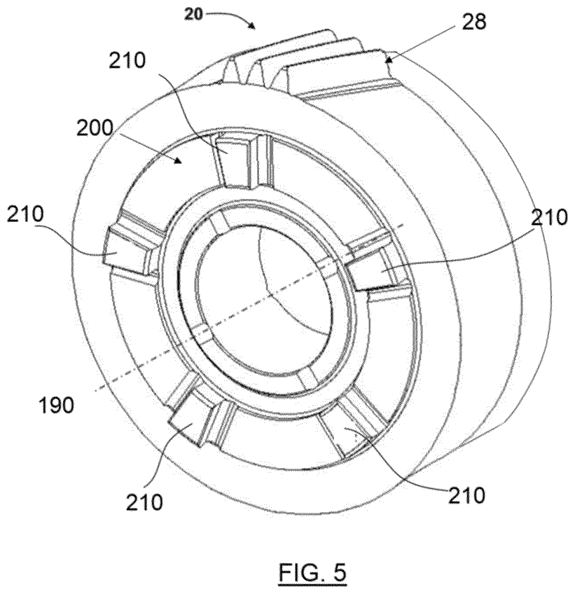

In an alternative embodiment, as shown in FIGS. 3A and 4B, each ramp 130 circumferentially extends from the front face 180 of the sliding member 100 to its recess 120. In this configuration, the slope of the ramp is (substantially) constant from the front face 180 to the edge of the recess to ensure a smooth guidance for the protrusions 210 during a shifting from a decoupled state to a coupled state. In another words, there is no intermediate bottom 140 between the ramp 130 and its adjacent recess 120.

The sliding sleeve 100 in FIG. 3A differs from the sliding sleeve in FIG. 3B in that the FIG. 3A comprises 8 cavities instead of 5. Furthermore, the ramps 130 in FIG. 3A form a relatively smooth surface while each ramp 130 in FIG. 3B is formed on the top of a ridge circumferentially extending from the corresponding recess 120 to the front face 180. It should be noted that each ramp 130 and its bottom 140 in FIG. 2 are also formed on the top of a ridge circumferentially extending from the corresponding recess 120 to the front face 180.

FIG. 4A shows a transversal cut of a cavity 110 and a protrusion 210, when torque is transferred from the input member 20 to the differential case 80. This situation typically occurs when the motor drives the wheels. A side surface of the protrusion 210 abuts against the corresponding abutment surface 150 formed in the recess 120. The recess 120 comprises two opposed undercuts 160. The undercut 160 on which the protrusion abuts ensures that the sliding sleeve 100 locks the input member 20 when the torque is transferred from the protrusion 210 to the sliding sleeve 100.

FIG. 4B shows a transversal cut when the electric motor is either in a reverse mode or driven by the wheels. In this case, the abutment surface 150 is shifted to the opposite side.

FIG. 4B shows a transversal cut when the motor either turns backwards or is driven by the wheels. In this case, the abutment surface 150 is shifted to the opposite side.

FIG. 4C shows a switching operation from a decoupled state to a coupled state in which the electric motor drives the vehicle. As can be seen, the protrusion 210 slides through the cavity 110 towards the recess 120. The cavity 110 and in particular the ramp 130 guides the protrusion 210 towards the recess 120 where a form-fitting engagement (e.g. undercut) is provided to transfer the torque. Advantageously, an electric motor allows a precise control of the speed of the input member 20. Equally, the speed of the sliding sleeve 100 can be precisely monitored with a speed sensor/angular sensor. Therefore, the relative speed between the first engaging member, namely the sliding sleeve 100 and the second engaging member, namely the input member 20 can be precisely controlled so as to ensure a smooth engagement of the protrusions 210 into their recess 120 during a switching operation from a decoupled state to a coupled state in which the electric motor drives the vehicle. Furthermore the axial displacement of the first engaging member, namely the sliding sleeve 100 can be controlled by an actuator piloted by a control unit. The axial displacement relates to the distance between the front face 180 of the sliding sleeve 100 and an opposite face formed on the input member 20, in particular a flange 26 of the outer annular housing 22. A clutch control unit can have as inputs: angular position of the first engaging member, namely the sliding sleeve 100 and the angular position of the second engaging member, namely the input member 20, and as output: a control signal representing an axial position of the first engaging member, namely the sliding sleeve 100.

As shown in FIG. 4C, a protrusion 210 may comprises side surfaces, the shape of which is adapted to be complementary to the undercuts 160 of the recess 120. The side surface may have an incline with the same angle of the ramp so as to slide on it.

As shown in FIG. 4C, a protrusion 210 may include a top (flat head), the shape of which is adapted to slide on the ramp 130.

As shown in FIG. 4C, the top of the protrusion 210 can have a chamfer formed on an edge of said top. This chamfer can have an incline adapted to slide on the ramp 130.

A switching from a coupled state to a decouple state is not represented. In this transition phase, the electric motor speed is controlled so that the speed of the input member 20 is substantially equal to that of the differential case 80, while controlling the angular offset between the differential case 80 and thus the sliding sleeve 100 and the input member 20 and thus the protrusions 210 so that the protrusion heads can be retracted from the corresponding recesses 120. The axial position and/or speed of the sliding sleeve 100 is controlled as a function of angular signals (e.g. electric motor/input member and differential case). This switching can occur when the vehicle is in coast-down motion and when the electric motor control unit sends a control signal to initiate the release of the clutch mechanism of the differential assembly, so as to reduce losses in the transmission (e.g. bearing, windage, and splash losses).

FIG. 5 shows an input member 20 with protrusions 210 circumferentially arranged.

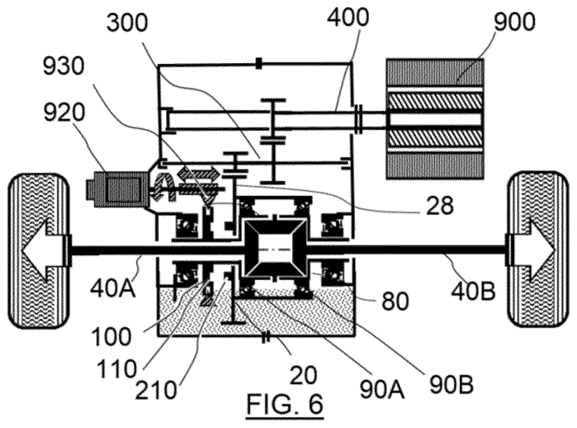

FIG. 6 shows a schematic representation of an embodiment of a power chain with an electric motor in an off-set configuration (motor axis being parallel to wheel axles) and a differential assembly according to the invention. The transmission shown is a single gear transmission. This transmission can be connected to one e-machine (SINGLE e-machine configuration) or two e-machines (DUAL e-machine configuration).

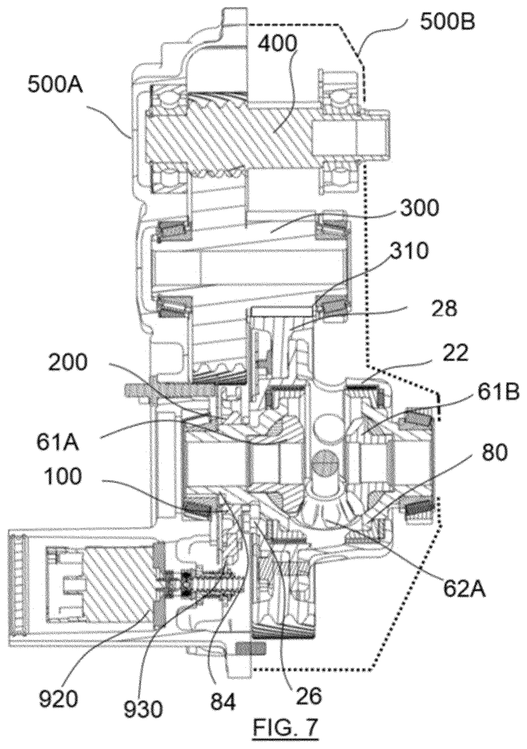

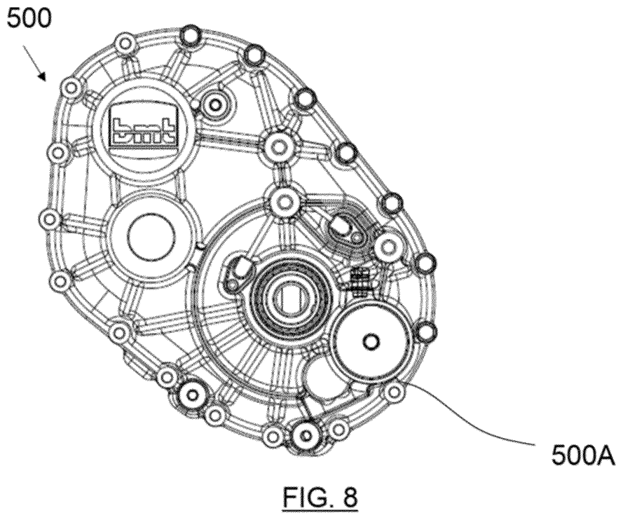

FIG. 7 shows transversal view of a transmission assembly in an off-set configuration. In both FIGS. 7 and 8, the transmission assemblies have a transmission casing 500, which houses a differential assembly.

The transmission assembly in FIG. 7 comprises a first transfer shaft 300 having a final pinion 310, which meshes with the final wheel 28 of the differential assembly. The first transfer shaft 300 has a first rotation axis parallel to the rotation axis of the differential case 80.

The transmission assembly in FIG. 7 comprises a second transfer shaft 400 comprising a second gear meshing with a first gear disposed on the first shaft 300, said second shaft having a second rotation axis parallel to the rotation axis of the differential case 80.

The transmission casing 500 in FIG. 7 comprises a first 500A and a second half 500B, each half 500A, 500B of the transmission casing 500 having the form of a shell (delimited by a rim), the first and the second half 500A, 500B further comprising bearing receiving housings for the first transfer shaft 300, the second transfer shaft 400 and a proximal and a distal end of the differential case 80, respectively. The second half 500B is represented by a dotted line.

In FIG. 7, the first engaging member 100 comprises a peripheral groove, in which a fork-type shifter is engaged. The fork-type shifter 930 is connected to an actuator, in particular a linear actuator 930 that is mounted on the transmission casing 500.

FIG. 8 shows a front view of the first half 500A of the transmission casing 500.

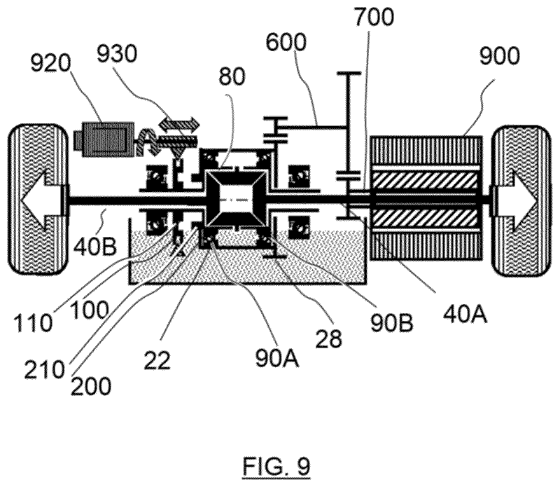

FIG. 9 shows a schematic representation of an embodiment of a power chain with an electric motor in coaxial configuration (motor axis being coaxial with wheel axles) and a differential assembly according to the invention. The transmission shown is a single gear transmission.

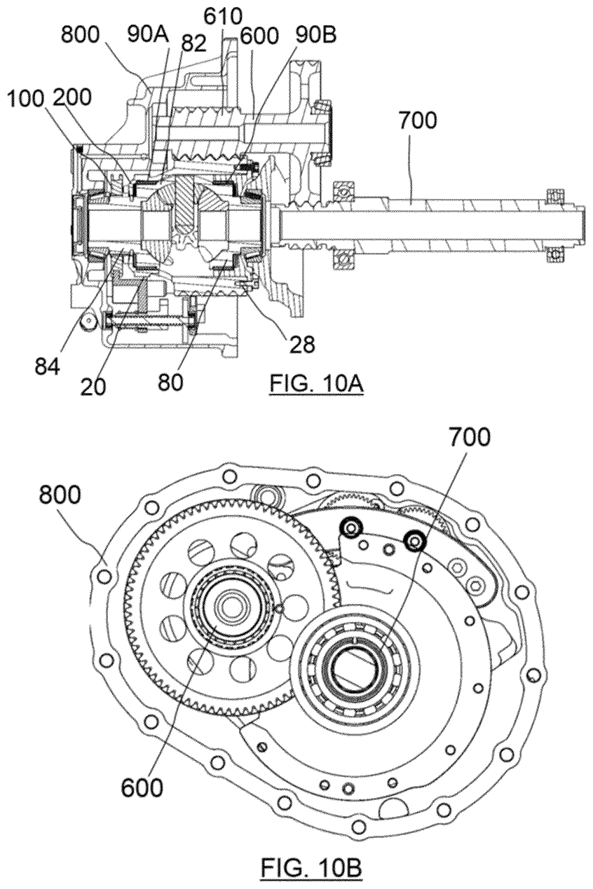

FIG. 10A shows a transversal view of a “coaxial” transmission assembly. The differential case is supported in rotation in a front cover 800 of a transmission casing. The transmission assembly has a first transfer shaft 600 having a final pinion 610, which meshes with the final wheel 22 of the differential assembly. The first transfer shaft 600 has a transfer rotation axis parallel to the rotation axis of the differential case 80. The transmission assembly is connected to a rotor shaft 700 for an electric motor (not represented), said shaft comprising a third gear meshing with a fourth gear disposed on the transfer shaft 600, said rotor shaft having a rotation axis coaxial with to the rotation axis of the differential case 80. The rotor shaft is hollow to accommodate a wheel axle.

FIG. 10B shows a rear view of the transmission assembly according to FIG. 10A.

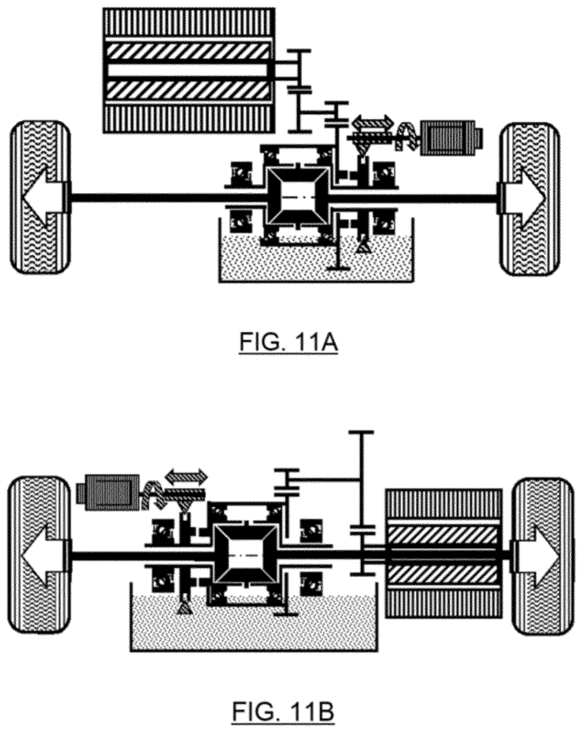

FIGS. 11A and 11B show devices similar to those in FIGS. 6 and 9 respectively, except that the first and the second engagement member each comprise a plurality of teeth (opposite rows of teeth disposed circumferentially). The first engagement member teeth are engaged with the second engagement member teeth in a form-fitting manner when the clutch is coupled. This design has the drawback that there is no guidance during the engagement of the rows of opposite teeth during switching. A switching operation with the system in FIGS. 11a and 11b is longer because a more precise synchronisation is required with a reduced relative angular tolerance for the positioning between the first and the second engagement member before they can be meshed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-31. (canceled)

32. A differential assembly for a vehicle, comprising:
an input member;
a first output member and a second output member;
a differential mechanism configured to differentially distribute a driving force inputted by the input member to the first output member and the second output member;
a differential case that accommodates the differential mechanism; and
a clutch mechanism configured to selectively transmit power between the input member and the differential case, the clutch mechanism comprising a first engaging member and a second engaging member configured to be releasably connected to one another such that the clutch mechanism is in a coupled state when the first engaging member and the second engaging member are engaged, and the clutch mechanism is in a decoupled state when the first engaging member and the second engaging member are disengaged,
wherein the first engaging member comprises at least one cavity in which a recess is arranged, and the second engaging member comprises at least one protrusion, the recess being configured to engage with the at least one protrusion so as to transmit the power either from the first engaging member to the second engaging member, or from the second engaging member to the first engaging member, when the clutch mechanism is in the coupled state, and
wherein the at least one cavity extends in a circumferential direction and is arranged such that the first engaging member is movable relative to the second engaging member during a switching from the decoupled state to the coupled state such that the at least one protrusion is movable, from the decoupled state, through the at least one cavity into the recess.

33. The differential assembly of claim 32, wherein the recess is arranged at a circumferential end portion of the at least one cavity.

34. The differential assembly of claim 32, wherein, in the coupled state, the at least one protrusion rests against an abutment surface formed on a portion of the recess, when torque is transmitted from the second engaging member to the first engaging member.

35. The differential assembly of claim 32, wherein, in the coupled state, the at least one protrusion is insertable into the recess in a form-fitting manner.

36. The differential assembly of claim 32, wherein the first engaging member comprises a front face in which the at least one cavity is arranged.

37. The differential assembly of claim 36, wherein the at least one cavity comprises a ramp.

38. The differential assembly of claim 37, wherein the ramp circumferentially extends from the front face of the first engaging member to the recess.

39. The differential assembly of claim 32, wherein the recess comprises an undercut, and
wherein the at least one protrusion comprises a side surface configured to be complementary to the undercut.

40. The differential assembly of claim 37, wherein the ramp is arranged at an end of the at least one cavity is opposite the recess in a circumferential direction.

41. The differential assembly of any of claim 37, wherein the ramp comprises a surface forming an angle with a bottom of the at least one cavity, the surface connecting the front face of the first engaging member with the bottom.

42. The differential assembly of claim 34, wherein the first engaging member comprises a front face in which the at least one cavity is arranged, and
wherein, in the coupled state, the at least one protrusion rests against an opposed abutment surface to an abutment surface formed on a portion of the recess when torque is transmitted from the first engaging member to the second engaging member, the abutment surface having a higher surface than the opposed abutment surface.

43. The differential assembly of claim 32, wherein the at least one cavity has a circular arc shape extending between two opposite circumferential edges formed in the front face of the first engaging member, and
wherein the at least one cavity has an inner radial edge and an outer radial edge formed in the front face of first engaging member.

44. The differential assembly of claim 37, wherein the at least one protrusion comprises a flat head, an incline of which is configured to be complementary to an incline of the ramp.

45. The differential assembly of claim 37, wherein a flat head of the at least one protrusion comprises a chamfer formed on an edge of the flat head, an incline of which is configured to slide on the ramp.

46. The differential assembly of claim 32, wherein the recess comprises two opposed undercuts.

47. The differential assembly of claim 32, wherein the clutch mechanism is arranged so as to allow the first engaging member to move relative to the differential case in an axial direction along a rotation axis of the differential case and to not allow the first engaging member to rotate relative to the differential case,
wherein the second engaging member is formed in or fixed to the input member,
wherein, in the coupled state, the input member is configured to synchronously rotate with the differential case,
wherein, in the decoupled state, the differential case and the input member are disconnected from each other so as to allow relative rotation between the input member and the differential case, and
wherein the input member comprises a final wheel.

48. The differential assembly of claim 32, wherein the differential assembly comprises an outer annular housing and inner annular housing arranged coaxially, and
wherein the outer annular housing is part of the input member and the inner annular housing is part of the differential case.

49. The differential assembly of claim 32, wherein the at least one protrusion comprises at least five and less than twelve protrusions, and
wherein the at least one cavity comprises at least five cavities and less than twelve cavities.

50. A transmission assembly, comprising:
the differential assembly of claim 32; and
a transmission casing housing the differential assembly, the transmission comprising:
a first transfer shaft comprising a final pinion meshing with the final wheel of the differential assembly, the first transfer shaft having a first rotation axis parallel to the rotation axis of the differential case; and
a second transfer shaft comprising a second gear meshing with a first gear disposed on the first transfer shaft, the second transfer shaft having a second rotation axis parallel to the rotation axis of the differential case,
wherein the transmission casing comprises a first half and a second half, each comprising a shell, the first half and the second half further comprising bearing receiving housings for the first transfer shaft, the second transfer shaft, a proximal end, and a distal end of the differential case, respectively, and
wherein the first half and the second half of the transmission casing comprise an opening for accommodating, respectively, the first output member and the second output member, the second half further comprising an opening for accommodating a second transfer shaft end adapted to be connected to a rotor shaft for an electric motor.

51. A transmission assembly, comprising:
the differential assembly of claim 32; and
a transmission casing housing the differential assembly, the transmission comprising:
a transfer shaft having a final pinion meshing with a final wheel of the differential assembly, the transfer shaft having a first rotation axis parallel to the rotation axis of the differential case; and
a rotor shaft for an electric motor, the rotor shaft having a third gear meshing with a fourth gear disposed on the transfer shaft, the rotor shaft having a rotation axis coaxial with the rotation axis of the differential case,
wherein the transmission casing comprises a front cover in which the differential assembly is supported during rotation.
